(19) United States
(12) Patent Application Publication
(10) Pub. No.: US 2012/0251044 A1
(43) Pub. Date: Oct. 4, 2012

(54) PRESSURE COMPENSATION MECHANISM FOR ROTARY DEVICES

(76) Inventors: Hong ZHANG, North Brunswick, NJ (US); Boying B. Zhang, Lawrenceville, NJ (US); Louis D. Violante, Monroe Township, NJ (US)

(21) Appl. No.: 13/072,867

(22) Filed: Mar. 28, 2011

(51) Int. Cl. G02B 6/26; H01R 39/00

(52) U.S. Cl. 385/25; 439/1

(57) ABSTRACT

The object of the present invention is that of a slip ring which utilizes one or more pistons to transfer the external pressure applied by the environment to an incompressible fluid in the inner cavity of the slip ring, thereby balancing the external and internal pressures resulting in a nominal, if any, pressure differential. This will enable the device to operated in environments with significantly higher ambient pressures then have been traditionally possible.

### BACKGROUND OF THE INVENTION

Electrical Slip rings, optical rotary joints, and other types of rotary devices have been used for some time to transmit a signal across a rotating interface. Their general construction consists of an internal mechanism to transmit the signal, such as a dove prism or brush rings, and an external casing intended to provide mechanical strength as well an environmental barrier to protect the internal mechanism from the elements. Since these device consist of at least two independently rotating segments it is impossible to employ permanent jointing/sealing techniques such as welding or brazing; therefore, packing and other types of seals must be employed to provide the critical environmental barrier.

Both packing and other seals mark the weak point of the environmental barrier, which often times means they are the limiting factor when determining the environmental operational limits of these types of rotary devices. One of the common limiting considerations imposed by packing and other seals is the maximum ambient operating pressure. This is because the risk of seal failure increases as the pressure differential between the external environment and the internal cavity increases. A large pressure differential will result in a leak and quite often lead to catastrophic failure. However, effectively balancing the external ambient pressures with the internal pressure would minimize if not totally eliminate this failure mode thereby greatly increasing the environmental operational limits of these types of devices.

It has been known for some time that a class of fluids called incompressible fluids has a density which remains constant for isothermal pressure changes. Neither the mass nor the volume of the incompressible fluid changes as the environmental pressure changes because the external pressure it is continually balanced by an equal internal pressure. This principle has been used effective in the field of hydraulics where a force or pressure is transmitted along a fluid line containing an incompressible fluid.

### SUMMARY OF THE INVENTION

The object of the present invention is that of a slip ring which utilizes one or more pistons to transfer the external pressure applied by the environment to an incompressible fluid in the inner cavity of the slip ring, thereby balancing the external and internal pressures resulting in a nominal, if any, pressure differential. This will enable the device to operated in environments with significantly higher ambient pressures then have been traditionally possible. For the purposes of this patent the term slip ring shall refer to electrical slip rings, optical rotary joints, or any other type of rotary device used to pass one or more electrical, electro-magnetic or both electrical and electro-magnetic signals across a rotating interface.

### BRIEF DESCRIPTION OF THE DRAWINGS

FIG. 1—a cross-section view of a mechanical embodiment of a pressure compensated rotary device.

### DETAILED DESCRIPTION OF THE INVENTION

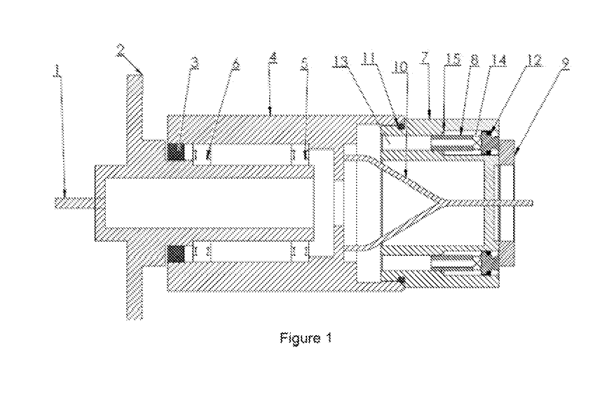

FIG. 1 shows a possible mechanical embodiment of the present invention. It consists of a rotor (2) and a stator (4), which are relatively rotatable through the bears (5 & 6). There is also a seal (3) which provides the environmental barrier between the external environmental and the component's internal cavity, which contains the mechanism for transmitting the signal across the rotating interface. Attached to both the rotor and stator sides is the rotor cable (1) and stator cable (10) respectively. These serve as the input and outputs for the electrical and/or electro-magnetic signals. It is possible for the device to be bi-directions in which case each cable would serve as both an input and an output. Also, attached to the stator is the housing for the pressure compensation module (7).

In this embodiment of the present invention the environmental barrier at the junction of the stator (4) and the housing for the pressure compensation module (7) is provided by another seal (11). However, since these two bodies are not relatively rotatable a more permanent joining/sealing technique can be used, such as welding or brazing. While different sealing techniques each impart their own set of benefits and drawbacks to the device the choice of one particular method or over another at this particular location does not significantly impact the operation or the effectiveness of the present invention.

The housing for the pressure compensation module (7) consists of one or more pressure compensation module and an external stop (9). The pressure compensation module consist of two co-axial bores of un-equal diameters (13 & 14) with the larger bore (14) connecting to the external environment to the smaller bore (13) and the smaller bore (13) connecting the larger bore (14) to the internal cavity. Therefore, the two bores together (13 & 14) form a continuous path from the external environment to the internal cavity. Within the bores is a piston (8). The smaller bore (13) is slightly larger than the piston's shaft enabling it to act as a guide ensuring the piston moves smoothly and evenly. The larger bore (14) is slightly larger than the piston's head and provides and internal stop (15) where it connects to the smaller bore (13) thereby limiting “downward” movement of the piston. The external stop (9) limits the “upward” movement of the piston preventing it from being dislodge from the housing for the pressure compensation module (7). There is also a seal (12) between the piston head and the larger bore (14) providing an environmental barrier between the external environment and the internal cavity. It is also possible to incorporate the pressure compensation modules directly into the rotor or the stator thereby eliminating the need for a separate housing for the compensation module. This difference, while altering the appearance of the device, does not significantly impact the operation or the effectiveness of the present invention.

The internal cavity of the device is also filled with an incompressible fluid. Therefore, as the external pressure on the device increases the “downward” force on the piston (8) increases. This pressure increase is transferred to the incompressible fluid via the piston (8). Since the total volume of the incompressible fluid remains the same the fluid would transfers that external pressure increase throughout the internal cavity of the device, as per Pascal's law. This ensures the pressure differential between the device's internal cavity and the external environment is approximately zero thereby, reducing if not completely eliminating this particular failure mode. While the only requirement for the fluid in the present invention is that it must be so called “incompressible” it is possible to select an incompressible fluid to serve several purposes. For example if this was being incorporated into an electrical slip ring it may be beneficial to choose an incompressible fluid with a high dielectric coefficient as to reduce the chance of a dielectric breakdown caused by a current jumping from one brush to another. Another example would be if this was being incorporated into an optical rotary joint, then it may be beneficial to choose an incompressible fluid with very good optical properties to reduce the insertion loss.

What is claimed is:

1. A pressure compensated rotary device having an electrical slip ring, an optical rotary joint, a hybrid electrical/optical slip ring, comprising:
a rotor side;
a stator side;
a mechanism for transmitting one or more signals across a rotating interface; and
a pressure compensation mechanism having internally sealed chamber filled with an incompressible fluid.

2. A pressure compensation mechanism for rotary devices of claim 1, further comprising:
a housing having an internally sealed chamber filled with an incompressible fluid and a high pressure side; and
at least one pressure compensation module of connecting the internal chamber and the external high pressure side.

3. A pressure compensation module of claim 2, further comprising:
a piston hole;
a piston, capable of moving freely inside of said piston hole with an internal and an external side;
an internal stop member to limit said piston's travel in one direction;
an external stop member to limit said piston's travel in the other direction; and
a seal providing an environmental barrier between the internal chamber and the external high pressure side.

4. A pressure compensated rotary device having an electrical slip ring, an optical rotary joint, a hybrid electrical/optical slip ring, comprising:
a rotor side;
a stator side;
a mechanism for transmitting one or more signals across a rotating interface internally sealed chamber filled with an incompressible fluid and a high pressure side; and
at least pressure compensation module in the rotor side, the stator side or in both the rotor and stator sides connecting the internal chamber and the external high pressure side.

5. A pressure compensation module of claim 4, further comprising:
a piston hole;
a piston, capable of moving freely inside of said piston hole with an internal and an external side;
an internal stop member to limit said piston's travel in one direction;
an external stop member to limit said piston's travel in the other direction; and
a seal providing an environmental barrier between the internal chamber and the external high pressure side.
